(19) United States
(12) Patent Application Publication
(10) Pub. No.: US 2015/0211697 A1
(43) Pub. Date: Jul. 30, 2015

(54) LUMINAIRE AND LUMINAIRE KIT

(71) Applicant: Nirit Sigal Packer, Herzelia (IL)

(72) Inventor: Nirit Sigal Packer, Herzelia (IL)

(21) Appl. No.: 14/224,231

(22) Filed: Mar. 25, 2014

Related U.S. Application Data
(63) Continuation-in-part of application No. 14/168,098, filed on Jan. 30, 2014, now abandoned.

(51) Int. Cl. F21S 4/00; F21V 8/00; F21V 21/06; F21V 3/04

(52) U.S. Cl. CPC F21S 4/006; F21V 3/049; G02B 6/0096; F21V 21/06; F21Y 2113/005

(57) ABSTRACT

A luminaire is in the form of a kit or assembled lamp utilizes a translucent vent pipe to house a serial string of low wattage lights which operate without excessive heat that would melt the vent pipe. A bendable stiffening rod is inserted into the vent pipe to which the light string is attached. By bending the rod the lamp can take on different preferred configurations and the rod will hold the desired bent shape. A light changing fabric cover provides a preferred shade that changes an aspect of the light transmitted therethrough. For example a blue color will provide a blue glow, a green color, a green glow. The fabric color may also be patterned to change the ambience the luminaire provides. Additional different covers may be provided.

### CROSS-REFERENCE TO RELATED APPLICATIONS

The present application is a continuation-in-part of U.S. patent application Ser. No. 14/168,090 filed Jan. 30, 2014, which is incorporated herein by reference.

### FIELD OF THE INVENTION

This invention relates to a luminaire or luminaire kit, which is in the form of a lamp, which can be configured in a plurality of positions and remain in those positions until otherwise reconfigured.

### BACKGROUND OF THE INVENTION

Light pipes of various types are ubiquitous. They are used in the automotive industry to guide light and they are used to illuminate a region with a tube or pipe. Tungsten tubes are light pipes which are used to illuminate an area around. Light within these tubes is diffused and provides a relatively uniform glow and illumination. This invention utilizes several known, commercially available, products in a novel and inventive arrangement to provide a decorative, functional luminaire that can be free-standing, mounted on a stand or which can be supported from a hook. Most importantly the invention provides a flexible tube which can be formed into a preferred shape and maintain that shape until otherwise reformed into a different shape.

Typically functional decorative lamps have a predetermined shape and provide light that is dependent to some extent upon a shade used to guide of diffuse the light from a bulb housed within. Such lamps have been used for decades and have served their intended purpose.

Over the past decade, inexpensive semiconductor lighting has become ubiquitous. These lights are sometimes sold in strings of serially connected semi-conductor lights. Advantages of using such lighting, for example LEDs is that they consume relatively little power compared with conventional resistive incandescent lights, and they operate at much lower temperatures. Lower temperature operation provides a light, which runs cooler than incandescent lights and does not waste power in producing light. Advantageously, a light that operates without excessive heating allows it to be housed within a housing that is made of plastic with a relatively low melting temperature. Commercially available plastic venting pipe is ubiquitous, inexpensive, relatively tolerant to heat of up to about 90° C. before melting, is flexible yet maintains its circular or rectangular cross-section, and is substantially translucent. Although its intended purpose is serving as conduit to pass warm air, we have discovered “unexpectedly” that it can function as a light-pipe wherein its translucent body diffuses light disposed within, in a desired manner. Furthermore, we have discovered that form fitting a form fitting cover over the venting pipe, serves as a decorative covering as well as a means in which to alter an aspect of the light passing through the translucent plastic venting pipe. By form fitting the cover over the light-pipe, its wire frame structure can be discerned providing section-breaks along its length defined by its spiral inner structure. This has a more pleasing effect than a continuous tube without these boundaries.

### SUMMARY OF THE INVENTION

In accordance with an aspect of this invention a luminaire capable of being configured in a plurality of different configurations comprises: a length of flexible tube having a diameter of at least two inches, said tube being translucent so as to diffuse light and to allow the diffused light to pass therethrough;

a string of serially connected semi-conductor lights housed within and along a length of an interior of length of flexible tube; and, a light altering decorative cover for changing an aspect of the light passing through a side of the length of flexible tube, disposed over at least a portion of the length of flexible tube wherein the cover is sized to fit over and substantially conform to the flexible tube; and, a length of stiffening material disposed within the interior of the length of flexible tube for confining the length of flexible tube in a desire shape corresponding to the shape of the length of the stiffening material. The length of stiffening material is preferably in the form of a rod or multiple strands of wires. This stiffening member can be used a means for supporting the flexible tube.

In accordance with another aspect of the invention a kit is provided comprising a length of flexible tube having a diameter of at least two inches, said tube being translucent so as to diffuse light and to allow the diffused light to pass therethrough; a string of serially connected semi-conductor lights to be housed within and along a length of an interior of length of flexible tube; and, a light altering decorative cover for changing an aspect of the light passing through a side of the length of flexible tube, wherein the cover is sized to fit over and substantially conform to the flexible tube; and a stiffening member.

### BRIEF DESCRIPTION OF THE DRAWINGS

Exemplary embodiments of the invention will now be described in conjunction with the drawings in which:

FIG. 1 is an isometric view of a kit of parts in accordance with an aspect of this invention;

FIG. 2 is an isometric view of a flexible translucent tube shown in FIG. 1;

FIG. 3 is a planar view and side view of a string of LED lights shown in FIG. 1;

FIG. 4 is an isometric view of a cloth cover shown in FIG. 1;

FIG. 5 is an isometric view of a luminaire in accordance with this invention, wherein the kit of parts shown in FIG. 1 is partially assembled.

### DETAILED DESCRIPTION

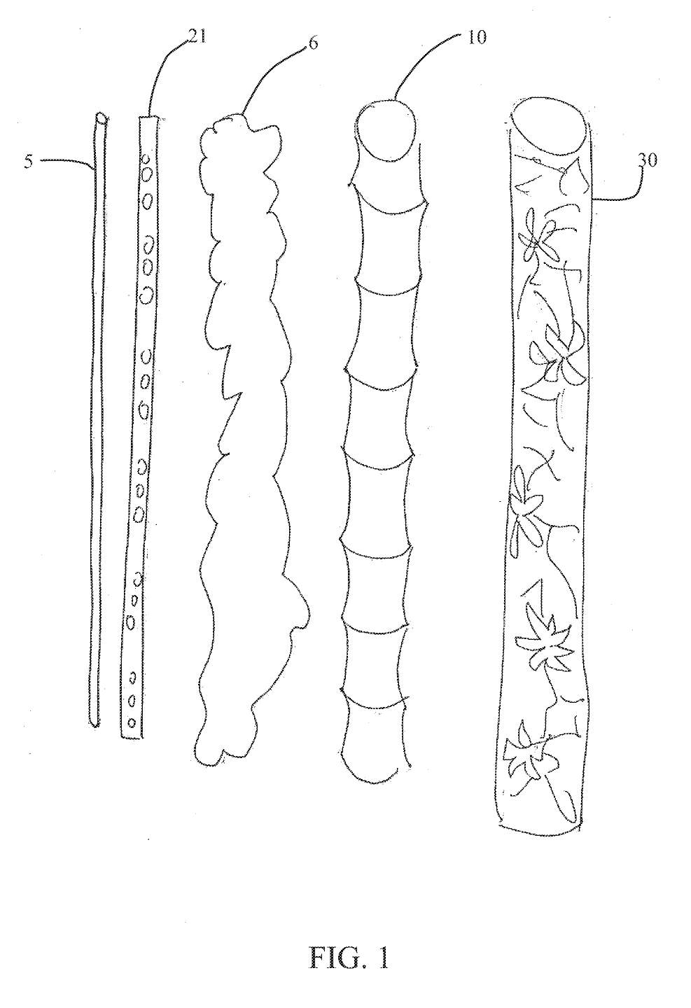

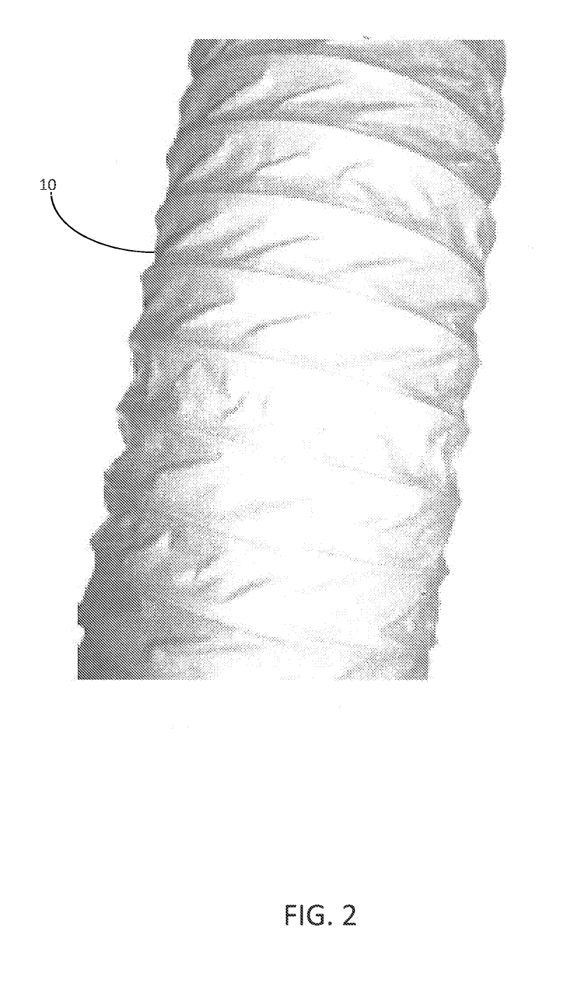

Turning now to FIG. 1 a kit of parts is shown, which when assembled forms a luminaire in accordance with this invention. A flexible metal rod 5 having a 6 mm diameter is shown next to an LED strip 20 of serially connected LED lights 21. A flexible duct tube 10 is shown next to a cloth cover 30. The commercially available flexible vent tubing 10 is shown in FIG. 2 having a spiral stiffing wire 12 housed within a sheath of translucent vinyl conduit 10. Tubing of this type can be purchased under the name Dundas Jafine Flexible Vinyl Ducting. Other commercially available duct tubing available at www.eccosupply.ca is SF-EVA which is translucent and has an operating temperature range of −65° F. and 200° F. Alternatively the vent tube may have a rectangular or square cross section.

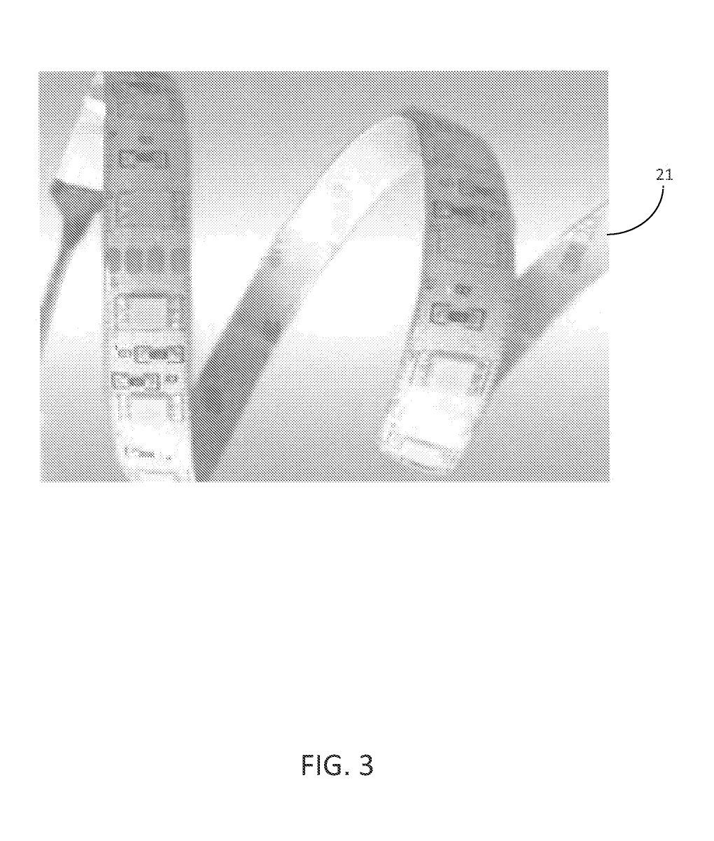

The LED strip 20 shown in FIG. 1 is shown in more detail in FIG. 3. Preferably the LED strip and the stiffening rod 5 is covered in cellophane 6 and when the LED strip of serially connected LED lights is inserted into the flexible vent tubing 10 the lights don't make contact with the vent tubing. The melting point of the cellophane is 175-205° C. The cellophane provides two functions; it serves to diffuse the light from the LED strip so that the light viewed from the outside of the lamp is substantially uniform. This added diffusion of the light also obfuscates the stiffening rod so that its outline is not perceived when viewing the light from the lamp. Furthermore the cellophane protects the LEDs and protects the flexible vent tubing 10 from being damaged when the stiffener is adjusted in different positions by bending the tubing 10 which in turn bends the stiffener 5. The LEDs should be selected such that they don't exceed a temperature at which the cellophane or the tubing 10 can burn. Thus, it is important to ensure that the semiconductor lighting string placed within the tubing does not heat the vinyl tubing to temperatures in excess of the range in which it is rated to operate.

Other commercially available ducting is available with even higher operating temperatures. The duct should be selected with a desired amount of light transmissivity. In a preferred embodiment the vinyl duct will diffuse the light such that the individual lights within cannot be easily seen but enough light should pass therethrough effectively providing a warm relatively even glow. Clear duct can be used but is less preferred.

FIG. 3 shows a string of LED semi-conductor lights 20 wherein the lights are connected in series having a plug 18 on one end. The sting of lights are placed within the vinyl tubing 10 are fixed in place by attaching the end of the string opposite the plug 18 end to a location near an end of the flexible tubing so that the lights 20 remain within the vinyl tubing 10.

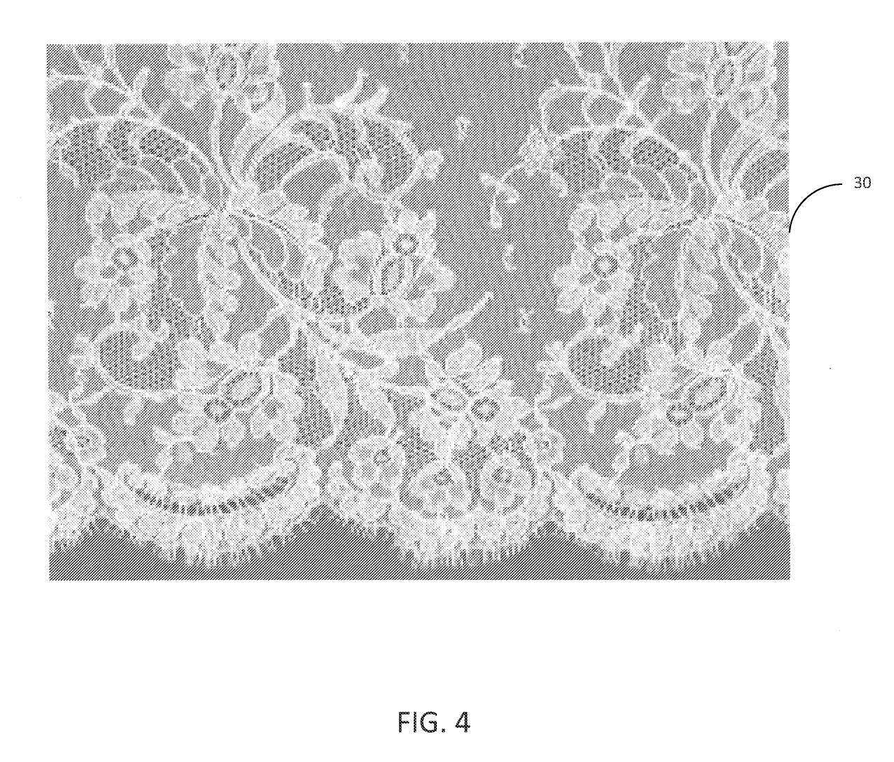

Turning now to FIG. 4 a portion of the cloth cover or sleeve 30 is shown in the form of a tube of material that is sized to snuggly accommodate the length of vinyl tubing 10. The cover 30 is preferably of desired color so that when the light is on, the color of the cloth cover is predominantly visible, casting a glow in that selected color. Furthermore the cover or sleeve 30 can be patterned so that the pattern is highly visible as light emanates through the cover to an observer of the luminaire. Preferably the sleeve 30 is diaphanous and is patterned and is a white or cream color such that it takes on the color of a selectable color LEDs 20 housed within the vinyl tubing 10. By providing a weave or pattern where some regions are more dense than others, these differing regions appear as darker and lighter colors of the LEDs within. This in combination with the visual separations from the spiral wire within the vinyl tubing 10 provides a pleasing effect. Thus it is preferable that the sleeve 30 be form fitting enough so that it substantially conforms to the exterior shape of the vinyl tubing.

In a preferred embodiment ends open ends of the sleeve 30 have complementary attachments so that the two ends can be connected together forming a continuous loop. Of course the continuous loop may be formed into various configurations by bending the stiffening rod. Velcro provides a simple means of attaching the two ends together wherein complementary Velcro connectors are sewn to ends of the sleeve 30.

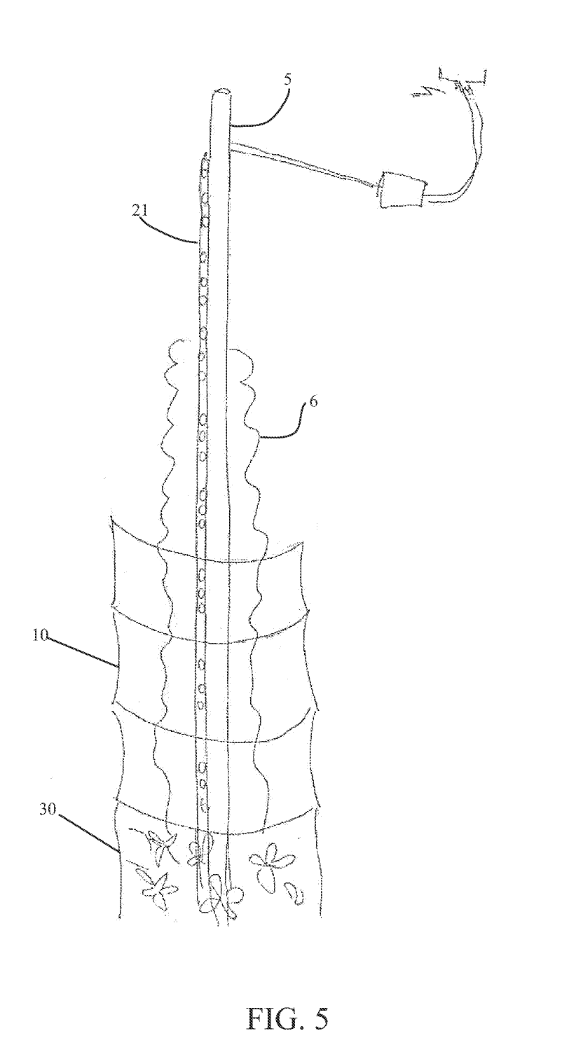

FIG. 5 illustrates the sleeve 30 partially covering the vinyl tubing 10 for illustrative purposes. Of course the sleeve should fully cover the vinyl tubing 10 in operation so as to provide a pleasing lamp and ambience. The sleeve changes an aspect of the light transmitted through the vinyl tubing, by changing the color or changing a pattern seen. Advantageously the cover can be changed for another cover having different light changing properties.

In a preferred embodiment of the invention the string of LEDs are programmable so that a particular color of light or pattern of light, such as strobe, or flash or continuous is selected. A wireless controller may be provided.

When fully assembled the stiffening rod can be bent into a plurality of different configurations thereby fixing the outer tubing housing the stiffening rod in a position that corresponds to the bend or bends formed by the rod. Furthermore, the rod may have a base forming a stand or be attached to a base or stand.

What is claimed is:

1. A luminaire capable of being configured in a plurality of different configurations comprising:
a length of flexible tube having a diameter of at least two inches, said tube being translucent so as to diffuse light and to allow diffused light to pass therethrough;
a string of serially connected semi-conductor lights housed within and along a length of an interior of length of flexible tube;
a patterned decorative cover, for allowing light to pass through such that the pattern is visible and highlighted when the semi-conductor lights are operational, wherein the cover is disposed over at least a portion of the length of flexible tube wherein the cover is sized to fit over and substantially conform to an outer surface of the flexible tube;
a bendable stiffening member within the flexible tube for allowing a user to configure the length of flexible tube in a plurality of positions and to maintain a desired position after bending the stiffening member; and
releasable means for holding ends of the length of flexible tube in close proximity so that the ends appear to be joined.

2. A luminaire as defined in claim 1 wherein patterned decorative cover is at least partly diaphanous and wherein the density of the pattern varies such that some regions allow more light to pass and other regions allow less light to pass therethrough.

3. A luminaire as defined in claim 1 where the average diameter of the length of flexible tube is less than 12 inches and wherein the serially connected semiconductor lights can be programmed to display one of a plurality of colors, one at a time.

4. A luminaire as defined in claim 2 wherein the releasable means for holding ends of the length of tubing in close proximity are complementary Velcro attachments coupled to ends of the patterned decorative cover.

5. A luminaire as defined in claim 1 wherein the bendable stiffening member is a longitudinal member in the form of a rod or wire coupled to the string of semi-conductor lights.

6. A luminaire as defined in claim 5 further comprising a light transmissive insulating material covering most of the string of semiconductor lights and the stiffening member for providing a barrier between inner walls of the length of flexible tube and the string of semi-conductor lights while allowing light to pass therethrough when the lights are operational.

7. A luminaire as defined in claim 6 wherein the light altering cover is made of fabric.

8. A luminaire as defined in claim 1 wherein the stiffening member is rod and wherein the string of serially connected semi-conductor lights is affixed to the rod.

9. A luminaire as defined in claim 6 wherein light transmissive insulating material is cellophane.

10. A luminaire kit comprising:
a length of flexible tube having a diameter of at least two inches, said tube being translucent so as to diffuse light and to allow the diffused light to pass therethrough;
a string of serially connected semi-conductor lights to be housed within and along a length of an interior of length of flexible tube;
a light altering decorative cover is sized to fit over and substantially conform to the flexible tube; and
a stiffening member for placement in the length of flexible tube.

11. A kit as defined in claim 10 wherein the string of serially connected semi-conductor lights is shorter than the length of the length of flexible tubing and wherein the length of the lights and wire interconnecting the lights and wire to plug in the lights together is longer than the length of the flexible tubing.

12. A kit as defined in claim 10 wherein the light altering decorative cover has attachment means at each end for coupling the ends together.

13. A kit as defined in claim 10 wherein the light altering decorative cover is a patterned diaphanous material.

14. A kit as defined in claim 13, wherein length of flexible tube is a commercially available venting hose having a diameter of between 3 and 8 inches.

15. A kit as defined in claim 14 wherein the semi-conductor lights are LEDs.

16. A kit as defined in claim 14 wherein the length of flexible tube has a spiral stiffening member for maintaining providing a substantially uniform cross-section of the flexible tube.

17. A kit as defined in claim 16 wherein the light altering cover is made of fabric and is has the shape of a tube.

18. A kit as defined in claim 17 further comprising a sleeve for housing the LEDs and the stiffening member.

19. A kit as defined in claim 12 further comprising a longitudinal bendable stiffening member for placing within the flexible tubing and for supporting the serially connected semiconductor lights.

20. A kit as defined in claim 19, wherein the longitudinal bendable stiffening member forms a stand.
